(19) United States
(12) Patent Application Publication
(10) Pub. No.: US 2006/0280338 A1
(43) Pub. Date: Dec. 14, 2006

(54) Systems and methods for the visually impared

(75) Inventor: Khalid Rabb, Fairport, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/147,493

(22) Filed: Jun. 8, 2005

(51) Int. Cl. G06K 9/00; G10L 21/06

(52) U.S. Cl. 382/114; 704/271

(57) ABSTRACT

Embodiments herein provide/acquire a document in electronic form (e.g., by receiving, copying, retrieving from storage, scanning combined with optical character recognition, etc.) and receive user input regarding visual impairment. In response to one or more levels of user visual impairment, embodiments herein automatically change (for example, immediately after scanning text) an appearance of the document, without requiring any user input, other than the visual impairment input. More specifically, when changing the appearance of the document, embodiments herein can increase the size of characters in the document, change the contrast or coloring of the text and/or background, and provide text-to-speech conversion of the document, thereby (in one embodiment) producing audio output of the text-to-speech conversion in coordination with a corresponding portion of the document being displayed. When changing the appearance of the document, embodiments herein also reformat the document (e.g., around graphic elements) to accommodate the increased size of the characters.

### BACKGROUND

Embodiments herein generally relate to methods and systems that increase the readability of documents for the visually impaired. As described in U.S. Pat. No. 5,475,399 (incorporated herein by reference), individuals who suffer visual impairments yet who are not totally blind do not enjoy the ability to readily pick up books, commercially available periodicals and newspapers or the like for the purpose of casual or even extensive reading. Regardless of where one chooses to read and under what circumstances, visually impaired persons would be greatly served by a unit which would allow them see text in a comfortable font size because commercially available printed books, periodicals and newspapers are often printed with very small text usually on the order of approximately three point or so requiring an individual even with normal eyesight to strain while reading. Although visually impaired, these individuals nevertheless possess the ability to read quite well if text is presented for reading in large enough font sizes. Additionally, since the vision of each individual may be impaired to a different degree than another, variable font sizes should be provided for allowing each user to read comfortably in relation to their own degree of visual impairment. While a visually impaired person may be able to use alternative media sources for obtaining daily news or periodical literature, such as often found in the form of audio tapes or the like, such sources however fail to allow the visually impaired individual the opportunity to exercise their reading skills. Moreover, such tapes do not allow the user to select a pace comfortable to his or her understanding and compression. Additionally, audio tape libraries do not always have the most current information available such as in the case of newspapers where timely dissemination of information is most important to its value.

Some headway has been made in the area of electronic data storage of text for portable reading devices, but the needs of those who require additional aid for reading materials such as aforementioned have simply not been met. These also include those individuals who simply suffer from vision fatigue caused by eyestrain attributable to the constant stress brought about by reading text having a small font size. With the advent of graphic scanners and character recognition programs as well as high volume, inexpensive, storage media, read only memory (ROM) and random access memory (RAM) chips, the ability now exists to download voluminous textual information and data into transferable memory media. Thus, visually impaired individuals would be greatly served if they could readily read from a unit in which means are provided for easily varying the font size of the characters displayed on the reading device. A reading unit having a screen capable of presenting characters in variable font sizes is described in U.S. Pat. No. 5,475,399 for readers, such as the visually impaired, allowing them to read characters in a font size most comfortable to them. The reader effects font size changes by depressing a font size select button, in turn activating a counter incremented the number of times the button has been depressed to generate the corresponding size font desired. The incremented counter may be used to address a particular place in memory where bit-mapped characters of different font sizes are stored or may be used as a scalar inputted into a character scaling algorithm to generate a desired character font size. The stored textual data may further be presented in useable form to the blind wherein an audible processor is utilized to convert the stored character code into audible signals inputted into a speaker.

U.S. Pat. No. 5,896,129 (incorporated herein by reference) discloses audio menuing capabilities for the visually impaired and closed captioning capabilities for the hearing impaired, as well as a graphical tab control input method and apparatus for use with an entertainment system. A headset to the entertainment system is installed for the users, and an audio menuing option may be selected by a visually impaired user by pressing an audio option button on a user control handset (PCH). In one embodiment of U.S. Pat. No. 5,896,129, the visually impaired user may be given a PCH with Braille raised dots (also referred herein as Braille dots) for easy tactile recognition of the input buttons on a PCH. The system uses an audio dialog to walk the user through the options available on the IFES menu displayed to the users on a display device. Each time a selection is made, audio information is given to the user acknowledging the selection. Given inputs from the user through use of the PCH, keystroke inputs from a user are transmitted to a seat electronics unit (SEU) coupled to the PCH and processed by a device driver residing in a memory of the SEU. The device driver transmits the keystroke inputs to a user interface module and to an audio menu module. In one embodiment of U.S. Pat. No. 5,896,129, the user interface module and the audio menu module both reside in the memory of the SEU. The user interface and the audio menu modules access a menu resource database on the SEU to retrieve the appropriate user output in response to the user inputs (keystrokes). For the user interface module, the menu resource database makes available a file of various screen selections. For the audio menu module, the menu resource database makes available a file of various audio information corresponding to various user keystroke inputs. Once the appropriate user output information is retrieved from the menu resource database, the information is output to the user via a display device and a headset coupled to the SEU.

Thus, as shown above, prior solutions to the problem of providing visually impaired users with enhanced visual and audio aids required specialized devices or manual intervention.

### SUMMARY

Method embodiments herein provide/acquire a document in electronic form (e.g., by receiving, copying, retrieving from storage, scanning combined with optical character recognition, etc.) and receive user input regarding visual impairment. In response to one or more levels of user visual impairment, embodiments herein automatically change (for example, immediately after scanning text) an appearance of the document, without requiring any user input, other than the visual impairment input. More specifically, when changing the appearance of the document, embodiments herein can increase the size of characters in the document, change the contrast or coloring of the text and/or background, and provide text-to-speech conversion of the document, thereby (in one embodiment) producing audio output of the text-to-speech conversion in coordination with a corresponding portion of the document being displayed. When changing the appearance of the document, embodiments herein also reformat the document (e.g., around graphic elements) to accommodate the increased size of the characters.

The levels of visual impairment requested from the user can comprise a predetermined scale (such as “good,” “below average,” “poor,”; a scale of 1 to 10, with 1 or 10 being poor; or any other easily implemented scale) and/or an optical refraction measurement of the user (e.g., +2.5, −1.0, 0.5, −4.0, etc.). This avoids having the user constantly being required to experiment with different font sizes, etc. Further, the amount that the appearance of the document is changed varies depending upon the level of visual impairment of the user. Thus, if the user has very poor eyesight, the size of the characters is increased more than if the user has only slightly poor eyesight. Similar graduated changes can be made to the color of the characters and/or background, the contrast and brightness of the display screen, etc. depending upon the severity of the visual impairment. Further, the automated decision of whether to combine the larger text with audio output of the spoken words can, in one embodiment, be based on the level of visual impairment of the user. Also, embodiments herein can store a visual impairment level of each different user and automatically perform the changing of the appearance of all documents requested by the currently identified user, thereby avoiding having the user repeatedly input his or her visual impairment information each time a document is scanned or retrieved.

A system embodiment utilizes a storage device to store the document in electronic form, even if only for momentary storage. A graphic user interface is used to receive the user input regarding visual impairment. Also, the system embodiment includes a processor that, in response to the one or more levels of visual impairment, automatically changes the appearance of the document by increasing the size of characters in the document, changing color/contrast, etc. A text-to-speech converter can be used to convert the text in the document into spoken words and an audio output is adapted to, under control of the processor, output the spoken words of the document in coordination with a corresponding portion of the document being displayed.

Again, the processor is used to reformat the document to accommodate the increased size of the characters. The system also can include a scanner to scan the document. For scanned documents, the processor performs the optical character recognition. The processor is also adapted to change the appearance of the document in different ways depending upon the level of visual impairment of the user. The storage device can also store the visual impairment level of the user to allow the processor to automatically change the appearance of all documents requested by the first user.

As described in greater detail below, embodiments herein provide end-to-end automation to enable push button conversion of hard-copy documents to audible documents, provide bulk/ batch processing of documents (for libraries, institutions, etc.), provide end-to-end automation to enable push button conversion of hard-copy documents to large-print format, and enable insertion of translation modules (e.g., English text translated to a foreign language, including audible documents in the foreign language).

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a flowchart illustrating method embodiments herein;

FIG. 2 is a flowchart illustrating method embodiments herein; and

FIG. 3 is a schematic representation of a system embodiment of embodiments herein.

### DETAILED DESCRIPTION

As discussed above, prior solutions to the problem of providing visually impaired users with enhanced visual and audio aids required specialized devices or manual intervention. This solutions presented herein provide automation of process, error proofing through automation, and customization when needed. These solutions enable significant cost savings by using software to leverage existing hardware equipment (e.g., multi-function devices (MFDs)) and generate output suitable for the visually impaired via an automated software workflow.

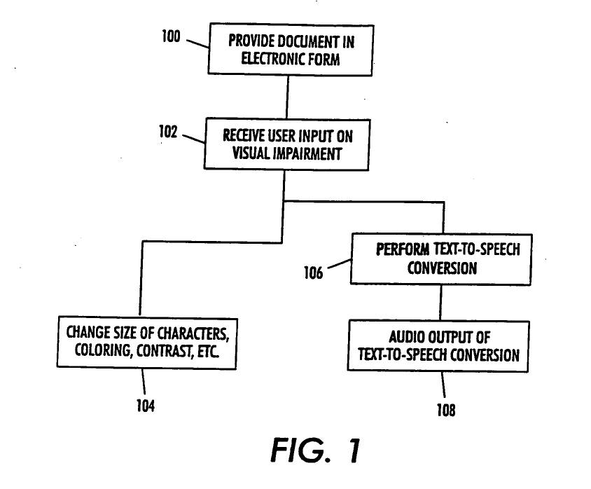

As shown in flowchart form in FIG. 1, embodiments herein provide/acquire a document in electronic form in item 100 (e.g., by receiving, copying, retrieving from storage, scanning combined with optical character recognition, etc.) and receive user input regarding visual impairment in item 102. In response to one or more levels of user visual impairment, embodiments herein automatically change (for example, immediately after scanning text) the appearance of the document in items 104, 106, and 108, without requiring any user input, other than the visual impairment input (102).

More specifically, when changing the appearance of the document, embodiments herein can increase the size of characters in the document, change the contrast or coloring of the text and/or background, (item 104) and/or provide text-to-speech conversion of the document (item 106), thereby producing audio output of the text-to-speech conversion in coordination with a corresponding portion of the document being displayed (item 108). When increasing the size of characters in the document (104), embodiments herein also reformat the document to accommodate the increased size of the characters around graphic items such as pictures, graphs, and tables.

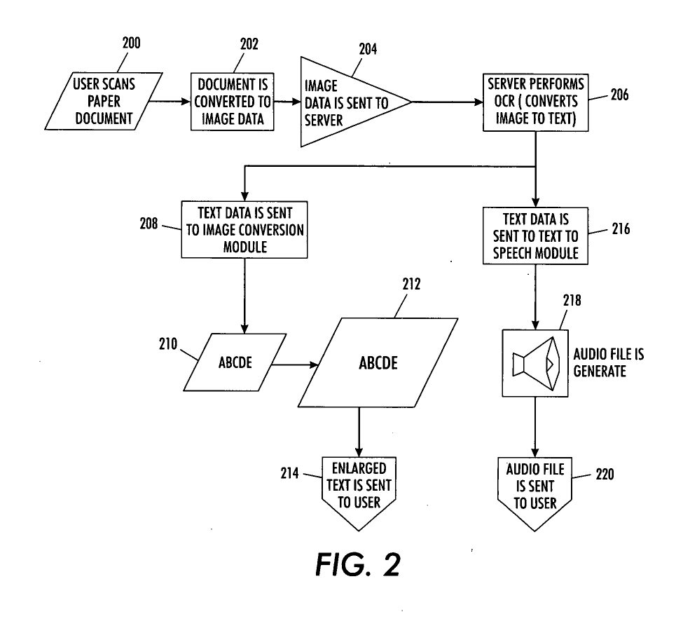

FIG. 2 provides a flow diagram illustrating aspects of one embodiment herein that allows a scanned hardcopy document to immediately and automatically be converted into a large print document (e.g., either on a graphic user interface display or a printed hardcopy) and to be optionally simultaneously output as audio output. More specifically, as shown in item 200, the user scans a paper document and in item 202 the document is converted into image data. In item 204, the image data is sent to a server and in item 206, the server performs optical character recognition (OCR) to convert the image into text. The text data is sent to an image conversion module in item 208 which changes the smaller text 210 into large print format text 212. Then, in item 214, the enlarged text is sent to the user in a file or as a hardcopy document. Thus, some embodiments herein provide end-to-end automation to enable push button conversion of hard-copy documents to audible documents, provide bulk/ batch processing of documents (for libraries, institutions, etc.), provide end-to-end automation to enable push button conversion of hard-copy documents to large-print format, and enable insertion of translation modules (e.g., English text translated to a foreign language, including audible documents in the foreign language). In a parallel operation, while simultaneously changing the appearance of the text, the text data can be sent to a text-to-speech module 216 which generates an audio file 218. The audio file is then sent to the user 220 either as a file or as audio output.

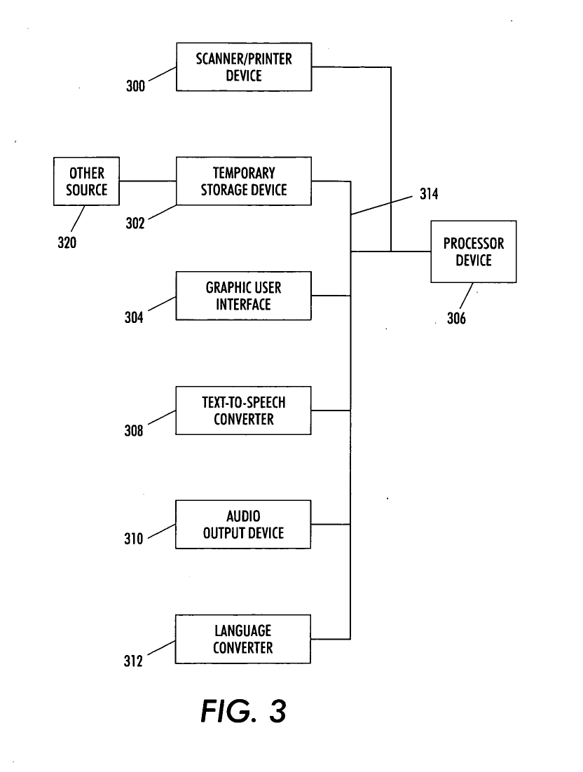

One exemplary system embodiment is shown in FIG. 3. The system includes a scanner/printer 300 used to scan and/or print documents. For example, item 300 can comprise any commercially available multi-function device (MFD) having the ability to scan, print, copy, fax, etc., or can comprise any stand alone printer and/or scanner available from, for example, Xerox Corporation, Standford Conn. A temporary storage device 302 receives the document from the scanner or some other source 320 (such as a network connection, permanent storage, a word processor, etc.) and temporarily stores the document in electronic form. This storage device 302 can comprise any form of storage, such as magnetic media (e.g., a hard drive) or electronic media (e.g., random access memory (RAM) and can be included in, or separate from the scanner 300.

A graphic user interface 304 is used to receive the user input regarding visual impairment. Also, the system embodiment includes a processor 306 that, in response to the level of visual impairment input by the user into the graphic user interface 304, automatically changes the appearance of the document by increasing the size of characters in the document, changing the contrast or coloring of the text and/or background, etc. A text-to-speech converter 308 is used to convert the text in the document into spoken words and an audio output 310 is adapted to, under control of the processor 306, output the spoken words of the document in coordination with a corresponding portion of the document being displayed on the graphic user interface 304 (text-to-speech software applications are commercially available from many vendors including, IBM Viavoice available from IBM Corporation, Armonk, N.Y., USA, Dragon Naturally Speaking available from Enable Mart, Vancouver, Wash., USA). Further, a language converter 312 is also available for operation under execution of the processor 306 to convert the language of the document (language converters are commercially available from vendors including Microsoft Corporation, Redmond, Wash., USA). Thus, embodiments herein enable insertion of translation modules (e.g., English text translated to a foreign language, including audible documents in the foreign language). All items shown in FIG. 3 can be connected to each other by way of wiring or network connections 314.

Again, the processor 306 is used to reformat the document to accommodate the increased size of the characters around graphic items. For scanned documents, the processor 306 performs the optical character recognition (optical character recognition software applications are commercially available, including Adobe Acrobat, available from Adobe Corporation, San Jose, Calif., USA). The processor 306 is also adapted to change the appearance of the document in different ways depending upon a level of visual impairment of the user. The storage device 302 can also store the visual impairment level of the user to allow the processor 306 to automatically change the appearance of all documents requested by that user.

The levels of visual impairment requested from the user can comprise a predetermined scale (such as “good,” “below average,” “poor,”; a scale of 1 to 10, with 1 or 10 being poor; or any other easily implemented scale) and/or an optical refraction measurement of the user (e.g., +2.5, −1.0, +0.5, −4.0, etc.). Further, the amount that the appearance of the document is changed varies depending upon the level of visual impairment of the user. Thus, if the user has very poor eyesight, the size of the characters is increased more than if the user has only slightly poor eyesight. Further, the automated decision of whether to combine larger text with audio output of the spoken words can, in one embodiment, be based on the level of visual impairment of the user. Thus, if the visual impairment is above (or below) a predetermined standard, embodiments herein not only automatically increase the size of the text, but also simultaneously output audio speech automatically, without requiring additional user intervention. Also, embodiments herein can store a visual impairment level of each different user and automatically perform the changing of the appearance of all documents requested by the currently active user, thereby avoiding having the user input his or her visual impairment information each time a document is scanned/retrieved.

Further, embodiments herein can be included in multiple functional units or a single multi-function device. Thus, one embodiment comprises a single stand-alone multifunction device that scans in a document, receives user input regarding visual impairment, and prints out a larger/different text document in what is essentially a “push button” operation.

Thus, as shown above, embodiments herein provide end-to-end automation to enable push button conversion of hard-copy documents to audible documents, provide bulk/ batch processing of documents (for libraries, institutions, etc.), provide end-to-end automation to enable push button conversion of hard-copy documents to large-print format, and enable insertion of translation modules (e.g., English text translated to a foreign language, including audible documents in the foreign language). Embodiments herein provide automation of process, error proofing through automation, and customization when needed. The solution enables significant cost savings by using software to leverage existing hardware equipment (MFDs) and generate output suitable for the visually impaired via an automated software workflow.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method comprising:
providing a document in electronic form;
receiving user input regarding visual impairment; and
in response to one or more levels of visual impairment, automatically changing an appearance of said document,
wherein said changing of said appearance of said document comprises increasing a size of characters in said document.

2. The method in claim 1, wherein said levels of visual impairment comprise one of a predetermined scale, and an optical refraction measurement of said user.

3. The method in claim 1, wherein said changing of said appearance of said document further comprises reformatting said document to accommodate an increased size of said characters.

4. The method in claim 1, wherein said providing of said document comprises scanning said document and performing optical character recognition on scanned documents.

5. The method in claim 1, wherein said changing of said appearance of said document varies depending upon a level of visual impairment of said user.

6. The method in claim 1, further comprising storing a visual impairment level of a first user and automatically performing said changing of said appearance of all documents requested by said first user.

7. A method comprising:
providing a document in electronic form;
receiving user input regarding visual impairment; and
in response to one or more levels of visual impairment, automatically changing an appearance of said document,
wherein said changing of said appearance of said document comprises:
increasing a size of characters in said document;
providing text-to-speech conversion of said document; and
producing audio output of said text-to-speech conversion in coordination with a corresponding portion of said document being displayed.

8. The method in claim 7, wherein said levels of visual impairment comprise one of a predetermined scale, and an optical refraction measurement of said user.

9. The method in claim 7, wherein said changing of said appearance of said document further comprises reformatting said document to accommodate an increased size of said characters.

10. The method in claim 7, wherein said providing of said document comprises scanning said document and performing optical character recognition on scanned documents.

11. The method in claim 7, wherein said changing of said appearance of said document varies depending upon a level of visual impairment of said user.

12. The method in claim 7, further comprising storing a visual impairment level of a first user and automatically performing said changing of said appearance of all documents requested by said first user.

13. A system comprising:
a storage device adapted to store a document in electronic form;
a graphic user interface operatively connected to said storage device, wherein said graphic user interface is adapted to receive user input regarding visual impairment; and
a processor operatively connected to said graphic user interface, wherein said processor is adapted to, in response to one or more levels of visual impairment, automatically change an appearance of said document by increasing a size of characters in said document.

14. The system in claim 13, wherein said levels of visual impairment comprise one of a predetermined scale, and an optical refraction measurement of said user.

15. The system in claim 13, wherein said processor is further adapted to reformat said document to accommodate an increased size of said characters.

16. The system in claim 13, further comprising a scanner operatively connected to said storage device, wherein said scanner is adapted to scan said document, wherein said processor is further adapted to perform optical character recognition on scanned documents.

17. The system in claim 13, wherein said processor is adapted to change said appearance of said document in different ways depending upon a level of visual impairment of said user.

18. The system in claim 13, wherein said storage device is further adapted to store a visual impairment level of a first user and said processor is further adapted to automatically perform said changing of said appearance of all documents requested by said first user.

19. A system comprising:
a storage device adapted to store a document in electronic form;
a graphic user interface operatively connected to said storage device, wherein said graphic user interface is adapted to receive user input regarding visual impairment; and
a processor operatively connected to said graphic user interface, wherein said processor is adapted to, in response to one or more levels of visual impairment, automatically change an appearance of said document by increasing a size of characters in said document;
a text-to-speech converter operatively connected to said processor, wherein said text-to-speech converter is adapted to convert text in said document into spoken words; and
an audio output operatively connected to said text-to-speech converter, wherein said audio output is adapted to, under control of said processor, output said spoken words of said document in coordination with a corresponding portion of said document being displayed.

20. The system in claim 19, wherein said levels of visual impairment comprise one of a predetermined scale, and an optical refraction measurement of said user.

21. The system in claim 19, wherein said processor is further adapted to reformat said document to accommodate an increased size of said characters.

22. The system in claim 19, further comprising a scanner operatively connected to said storage device, wherein said scanner is adapted to scan said document, wherein said processor is further adapted to perform optical character recognition on scanned documents.

23. The system in claim 19, wherein said processor is adapted to change said appearance of said document in different ways depending upon a level of visual impairment of said user.

24. The system in claim 19, wherein said storage device is further adapted to store a visual impairment level of a first user and said processor is further adapted to automatically perform said changing of said appearance of all documents requested by said first user.
